(19) United States
(12) Patent Application Publication
(10) Pub. No.: US 2024/0031487 A1
(43) Pub. Date: Jan. 25, 2024

(54) INFORMATION PROCESSING APPARATUS, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Misaki MATSUZAWA, Kanagawa (JP)

(73) Assignee: FUJIFILM Business Innovation Corp., Tokyo (JP)

(21) Appl. No.: 18/180,218

(22) Filed: Mar. 8, 2023

(30) Foreign Application Priority Data
Jul. 25, 2022 (JP) 2022-118299

(51) Int. Cl. H04M 3/523; G06Q 10/0631

(52) U.S. Cl. CPC H04M 3/5232; G06Q 10/063116

(57) ABSTRACT

An information processing apparatus includes a processor configured to, in a case where an urgency level determined based on details of an inquiry meets a predetermined condition, assign the inquiry to a person in charge of a second or later response that is a stage subsequent to a first response as a first point of contact.

### CROSS-REFERENCE TO RELATED APPLICATIONS

This application is based on and claims priority under 35 USC 119 from Japanese Patent Application No. 2022-118299 filed Jul. 25, 2022.

### BACKGROUND

### (i) Technical Field

The present disclosure relates to an information processing apparatus, an information processing method, and a non-transitory computer readable medium.

### (ii) Related Art

There has been a technique for assigning inquiries.

In Japanese Unexamined Patent Application Publication No. 2008-242985, a case management system at least including a contract information management database that stores details of a contract with a customer, a product information management database that stores detailed information about a product, a case management database that stores information about an inquiry case, and a person-in-charge information management database that stores information about technical skills, years of experience, and the like of a person in charge, registering an inquiry case input from a client to a case management server, and managing the registered inquiry case is disclosed. The case management system includes a team information management database that stores information about a team composed of a plurality of persons in charge. When an inquiry case occurs and is registered to the case management server, to assign the case that has been registered to the case management server to a team, the case management system calculates case handling capabilities of individual teams on the basis of the team information management database and the person-in-charge information management database. Then, the case management system assigns the handling of the inquiry case to a team with the highest case handling capability.

In Japanese Unexamined Patent Application Publication No. 2010-109895, a call center system is disclosed. The call center system includes a server apparatus that receives a predetermined communication call regarding an inquiry from outside, at least one terminal apparatus that is connected to the server apparatus to transmit and receive the communication call and includes a responsive processing screen, an input apparatus that receives at least an escalation operation for causing the server apparatus to transfer the predetermined communication call to one of a plurality of transfer destinations, and storing means for storing a history related to the predetermined communication call and storing at least information about an escalation performed by the server apparatus as the history related to the predetermined communication call. When the input apparatus receives an escalation operation, the responsive processing screen displays a plurality of transfer destination candidates on the basis of the information about the escalation recorded in the storing means.

### SUMMARY

A call center that receives inquiries from users provides a service in which a person in charge of the first response receives an inquiry as a first point of contact. If the person in charge of the first response is not able to solve the inquiry, a person in charge of the second response, which is the stage subsequent to the first response, deals with the inquiry.

Because a person in charge of the first response always receives an inquiry, a long time may be needed to respond to an urgent inquiry.

Aspects of non-limiting embodiments of the present disclosure relate to providing an information processing apparatus, an information processing method, and a non-transitory computer readable medium that are capable of reducing the time to respond to an inquiry, compared to a case where a person in charge of the first response always receives an inquiry.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus includes a processor configured to, in a case where an urgency level determined based on details of an inquiry meets a predetermined condition, assign the inquiry to a person in charge of a second or later response that is a stage subsequent to a first response as a first point of contact.

### BRIEF DESCRIPTION OF THE DRAWINGS

Exemplary embodiments of the present disclosure will be described in detail based on the following figures, wherein:

FIG. 1 is a schematic configuration diagram of an information processing apparatus according to an exemplary embodiment;

FIG. 2 is a block diagram illustrating a hardware configuration of an information processing apparatus according to an exemplary embodiment;

FIG. 3 is a block diagram illustrating a functional configuration of an information processing apparatus according to an exemplary embodiment;

FIG. 4 is a schematic diagram illustrating the flow of an assigning process of an information processing apparatus according to an exemplary embodiment;

FIG. 5 is a flowchart illustrating an assigning process of an information processing apparatus according to an exemplary embodiment;

FIG. 6 illustrates an example of a case table for an information processing apparatus according to an exemplary embodiment;

FIG. 7 illustrates an example of an analysis table for an information processing apparatus according to an exemplary embodiment;

FIG. 8 illustrates an example of an assigning table for an information processing apparatus according to an exemplary embodiment; and

FIG. 9 is a flowchart illustrating a response process of an information processing apparatus according to an exemplary embodiment.

### DETAILED DESCRIPTION

An example of an exemplary embodiment of a technique of the present disclosure will be described with reference to drawings. In the drawings, the same or equivalent component elements and parts are denoted by the same reference signs. Furthermore, for convenience of explanation, dimensional ratios in the drawings are exaggerated and may be different from actual ratios.

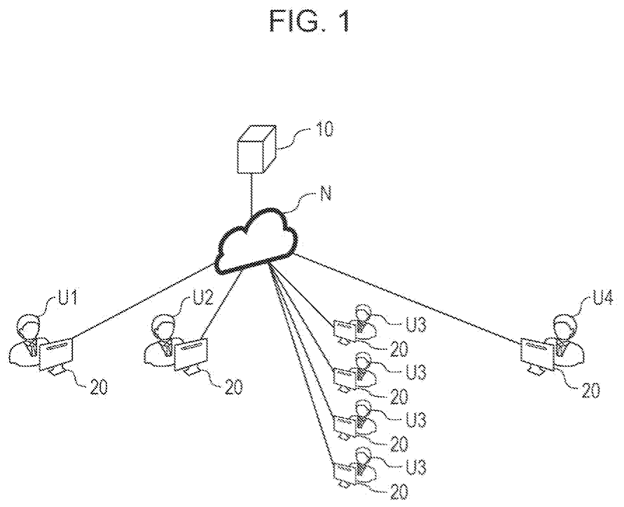

FIG. 1 is a schematic configuration diagram of an information processing apparatus 10 according to an exemplary embodiment.

The information processing apparatus 10 is a server that assigns an inquiry from an inquiring person U1 to a person in charge U2 of the first response, a person in charge U3 of the second response, or a person in charge U4 of the third response.

Terminal apparatuses 20 are smartphones, tablet terminals, personal computers, or the like connected to the information processing apparatus 10 through a network N. The person in charge U2 of the first response, the person in charge U3 of the second response, and the person in charge U4 of the third response respond to inquiries using the terminal apparatuses 20.

The inquiring person U1 is a user who makes an inquiry. The inquiring person U1 is, for example, a user who uses a product and makes an inquiry about a method for solving a failure of the product, a method for using the product, or the like.

The first response is the first point of contact for inquires. That is, the person in charge U2 of the first response is a person who receives an inquiry from the inquiring person U1. The person in charge U2 of the first response is, for example, an intermediary such as an agent or a seller of a product.

The second response is the stage subsequent to the first response. That is, the person in charge U3 of the second response is a person who responds to an inquiry to which the person in charge U2 of the first response is not able to answer. The person in charge U3 of the second response is, for example, an operator of the call center. For the second response, a team or a person in charge may be provided for each inquiry category, which will be described later.

The third response is the stage subsequent to the second response. That is, the person in charge U4 of the third response is a person who responds to an inquiry to which the person in charge U3 of the second response is not able to answer. The person in charge U4 of the third response is, for example, a developer of a product.

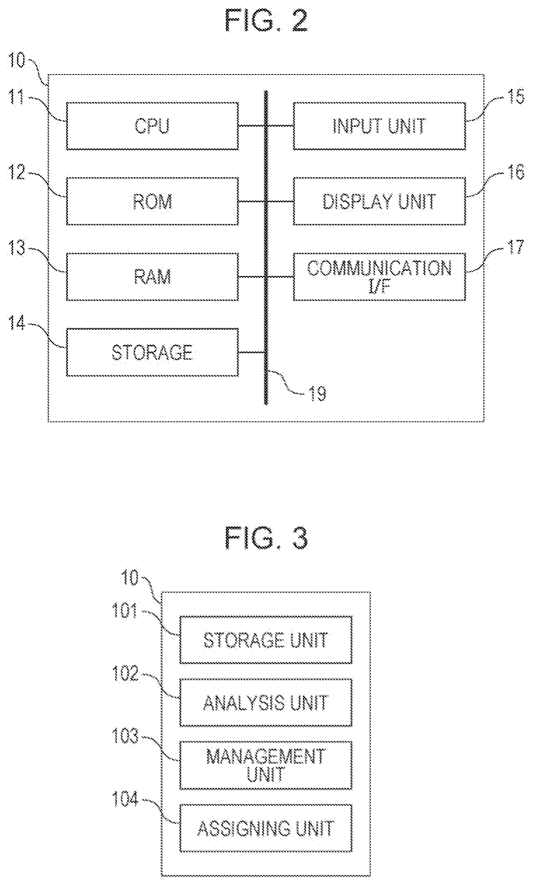

FIG. 2 is a block diagram illustrating a hardware configuration of the information processing apparatus 10 according to an exemplary embodiment. The information processing apparatus 10 includes a central processing unit (CPU) 11, a read only memory (ROM) 12, a random access memory (RAM) 13, a storage 14, an input unit 15, a display unit 16, and a communication interface (communication I/F) 17. The CPU 11, the ROM 12, the RAM 13, the storage 14, the input unit 15, the display unit 16, and the communication interface 17 are connected to one another through a bus 19 so that they are able to communicate with one another.

The CPU 11 is a central processing unit that executes various programs and controls the ROM 12, the RAM 13, the storage 14, the input unit 15, the display unit 16, and the communication interface 17. That is, the CPU 11 reads a program from the ROM 12 or the storage 14 and executes the program using the RAM 13 as a working area. The CPU 11 controls the ROM 12, the RAM 13, the storage 14, the input unit 15, the display unit 16, and the communication interface 17 and performs various calculation processes in accordance with the program recorded in the ROM 12 or the storage 14. In this exemplary embodiment, an information processing program for assigning an inquiry is stored in the ROM 12 or the storage 14.

Various programs and various data are stored in the ROM 12. A program or data is temporality stored in the RAM 13 as a working area. The storage 14 is a hard disk drive (HDD) or a solid state drive (SSD) and stores various programs including an operating system and various data.

The input unit 15 includes a pointing device such as a mouse and a keyboard and is used for various inputs.

The display unit 16 is, for example, a liquid crystal display and displays various types of information. The display unit 16 may include a touch panel and function as the input unit 15.

The communication interface 17 is an interface for communicating with other apparatuses such as a database. For example, standards such as Ethernet ® , Fiber Distributed Data Interface (FDDI), or Wi-Fi® are used for the communication interface 17.

Next, a functional configuration of the information processing apparatus 10 will be described.

FIG. 3 is a block diagram illustrating an example of the functional configuration of the information processing apparatus 10. The information processing apparatus 10 includes, as a functional configuration, a storage unit 101, an analysis unit 102, a management unit 103, and an assigning unit 104. The storage unit 101, the analysis unit 102, the management unit 103, and the assigning unit 104 are implemented when the CPU 11 reads the information processing program stored in the ROM 12 or the storage 14, loads the information processing program onto the RAM 13, and executes the information processing program.

The storage unit 101 stores details of an inquiry from the inquiring person U1 as case information.

The analysis unit 102 analyzes the case information. That is, the analysis unit 102 determines a category, priority level, and urgency level, on the basis of the details of the inquiry.

The management unit 103 manages the case information. That is, the management unit 103 determines a person in charge of the inquiry on the basis of the analysis result.

The assigning unit 104 assigns the case information to the person in charge. That is, the assigning unit 104 assigns the inquiry to a corresponding person in charge.

Next, an operation of the information processing apparatus 10 will be described.

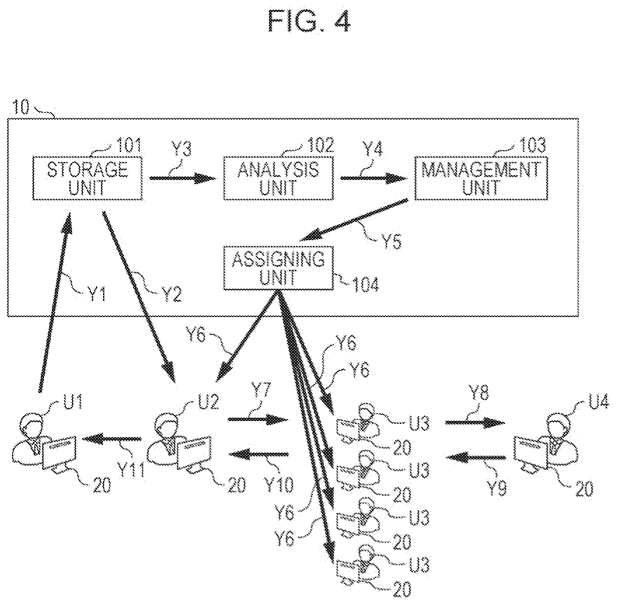

FIG. 4 is a schematic diagram illustrating the flow of an assigning process of the information processing apparatus 10 according to an exemplary embodiment.

An arrow Y1 indicates the flow of processing in which details of an inquiry are input as case information from a terminal apparatus 20 that is being operated by the inquiring person U1 to the storage unit 101. That is, the storage unit 101 receives the details of the inquiry from the terminal apparatus 20 that is being operated by the inquiring person U1.

An arrow Y2 indicates the flow of processing in which contract information is notified to a terminal apparatus 20 that is being operated by the person in charge U2 of the first response from the storage unit 101. The person in charge U2 of the first response may input supplementary information about the case information to the storage unit 101. That is, the storage unit 101 may receive the supplementary information about the case information input from the terminal apparatus 20 that is being operated by the person in charge U2 of the first response and store the received supplementary information.

An arrow Y3 indicates the flow of processing in which the case information is notified to the analysis unit 102 from the storage unit 101. The analysis unit 102 analyzes the details of the inquiry on the basis of the case information.

An arrow Y4 indicates the flow of processing in which an analysis result from the analysis unit 102 is stored into the management unit 103. The management unit 103 determines a person in charge of the inquiry on the basis of the analysis result.

An arrow Y5 indicates the flow of processing in which the person in charge of the inquiry is notified to the assigning unit 104 from the management unit 103. The assigning unit 104 assigns the inquiry to a corresponding person in charge of the inquiry.

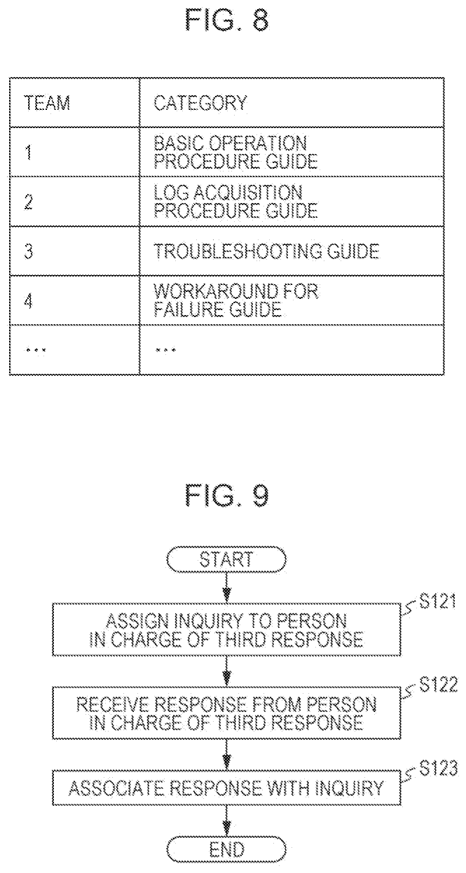

An arrow Y6 indicates the flow of processing in which the assigning unit 104 assigns the inquiry to the terminal apparatus 20 that is being operated by the person in charge U2 of the first response or a terminal apparatus 20 that is being operated by a person in charge U3 of the second response. To assign an inquiry to a person in charge U3 of the second response, the information processing apparatus 10 assigns, based on an assigning table illustrated in FIG. 8, the inquiry to a team or a person in charge for a corresponding category.

An arrow Y7 indicates the flow of processing in which the person in charge U2 of the first response makes an inquiry to the person in charge U3 of the second response. That is, in the case where the person in charge U2 of the first response is not able to answer the inquiry, the person in charge U2 of the first response makes an inquiry to the person in charge U3 of the second response.

An arrow Y8 indicates the flow of processing in which the person in charge U3 of the second response makes an inquiry to the person in charge U4 of the third response. That is, in the case where the person in charge U3 of the second response is not able to answer the inquiry, the person in charge U3 of the second response makes an inquiry to the person in charge U4 of the third response.

An arrow Y9 indicates the flow of processing in which the person in charge U4 of the third response responds to the person in charge U3 of the second response. The person in charge U4 of the third response may store details of the response to the inquiry in association with the details of the inquiry into the database. That is, the information processing apparatus 10 stores the details of the response that the person in charge U4 of the third response has made to the inquiry, in association with the details of the inquiry.

An arrow Y10 indicates the flow of processing in which the person in charge U3 of the second response responds to the person in charge U2 of the first response.

An arrow Y11 indicates the flow of processing in which the person in charge U2 of the first response responds to the inquiring person U1.

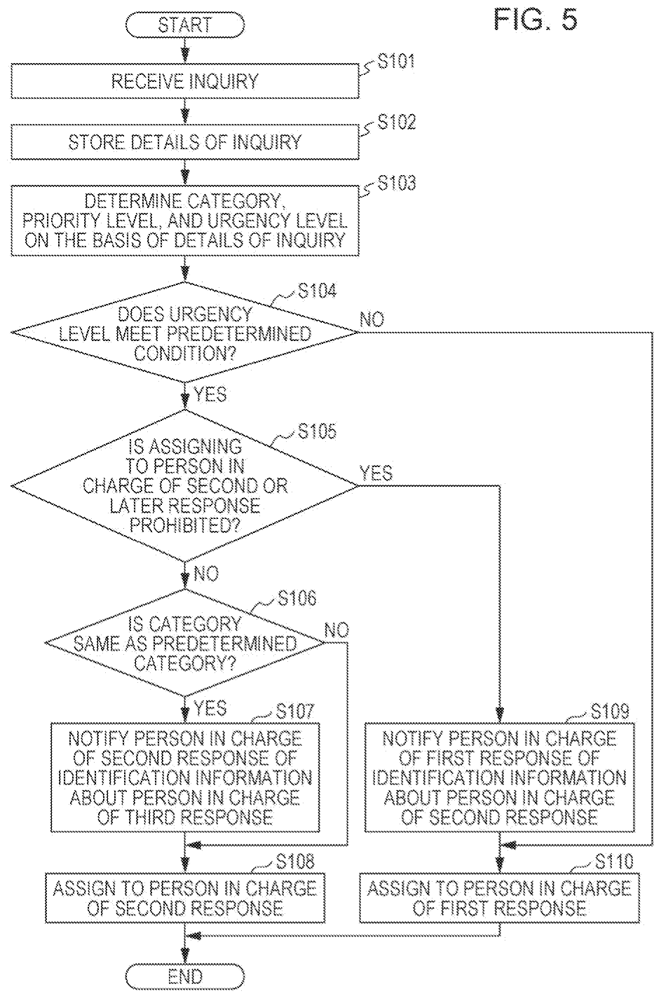

FIG. 5 is a flowchart illustrating an assigning process performed by the information processing apparatus 10. The assigning process is implemented when the CPU 11 reads an assigning program from the ROM 12 or the storage 14, loads the assigning program onto the RAM 13, and executes the assigning program.

In step S101, the CPU 11 receives an inquiry. That is, the CPU 11 receives an inquiry from the inquiring person U1. The CPU 11 may receive, for example, a log regarding a failure of a product. The CPU 11 proceeds to step S102.

In step S102, the CPU 11 stores details of the inquiry. For example, the CPU 11 registers the details of the inquiry as case information to a case table. The CPU 11 proceeds to step S103.

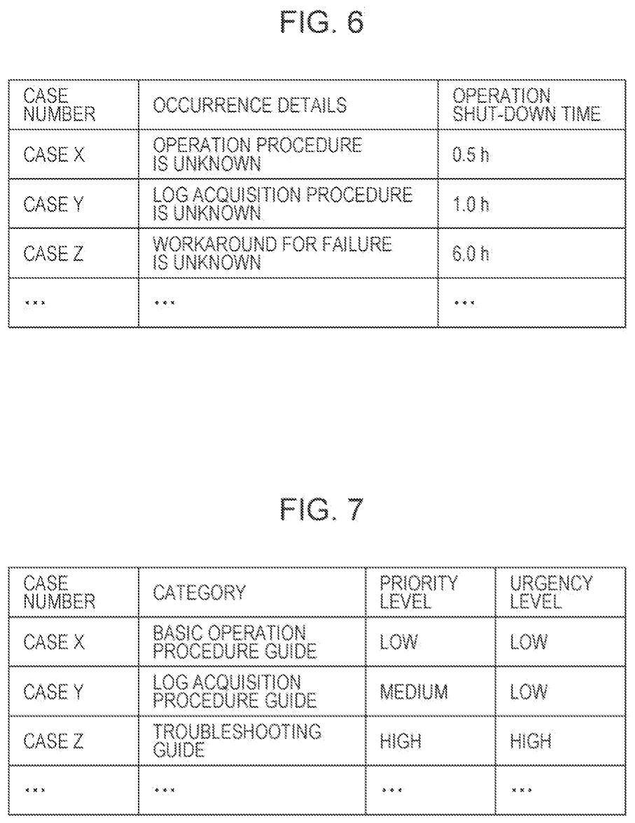

FIG. 6 illustrates an example of a case table for the information processing apparatus 10 according to an exemplary embodiment. The case table includes a case number field, an occurrence details field, and an operation shut-down time field.

The case number field is a field in which a value for identifying a case is stored. When receiving the inquiry in step S101, the information processing apparatus 10 issues a new case number.

The occurrence details field is a field in which details of the inquiry are stored.

The operation shut-down time field is a field in which time during which a product stops its operation.

In step S103, the CPU 11 determines a category, priority level, and urgency level on the basis of the details of the inquiry. For example, the CPU 11 stores the category, the priority level, and the urgency level into an analysis table. The CPU 11 proceeds to step S104.

FIG. 7 is an example of the analysis table for the information processing apparatus 10 according to an exemplary embodiment. The analysis table includes a case number field, a category field, a priority level field, and an urgency level field.

The category field is a field in which the category of an inquiry is stored. The information processing apparatus 10 stores a category determined based on the details of the inquiry into the category field. Categories include, for example, a basic operation procedure guide, a log acquisition procedure guide, a troubleshooting guide, a workaround for failure guide, and the like.

The priority level field is a field in which the priority level of the inquiry is stored. The information processing apparatus 10 stores the priority level determined based on the details of the inquiry into the priority level field. For example, in the case where past case information does not include similar inquiry details, the information processing apparatus 10 sets a high priority level. The priority level may be, for example, a numeric value or a classification of high, medium, and low.

The urgency level field is a field in which the urgency level of the inquiry is stored. The information processing apparatus 10 stores the urgency level determined based on the details of the inquiry into the urgency level field. For example, as the emergency shut-down time becomes longer, the information processing apparatus 10 sets a higher urgency level. The urgency level may be, for example, a numeric value or a classification of high, medium, and low.

In step S104, the CPU 11 determines whether or not the urgency level meets a predetermined condition. In the case where it is determined that the urgency level meets the predetermined condition (step S104: YES), the CPU 11 proceeds to step S105. In the case where it is determined that the urgency level does not meet the predetermined condition (step S104: NO), the CPU 11 proceeds to step S110. For example, the predetermined condition is that the priority level exceeds a predetermined value.

In step S105, the CPU 11 determines whether or not assigning to a person in charge of the second or later response is prohibited. In the case where it is determined that assigning to a person in charge of the second or later response is not prohibited (step S105: NO), the CPU 11 proceeds to step S106. In the case where it is determined that assigning to a person in charge of the second or later response is prohibited (step S105: YES), the CPU 11 proceeds to step S109.

Prohibiting assigning to a person in charge of the second or later response is, for example, prohibition based on a maintenance contract with the inquiring person U1, prohibition based on the details of the inquiry, or the like. The information processing apparatus 10 stores the details of the contract in association with the case information. For example, even in the case where the urgency level of the inquiry meets the predetermined condition, if assigning of the inquiry to a person in charge of the second or later response is prohibited, the information processing apparatus 10 assigns the inquiry to the person in charge U2 of the first response.

In step S106, the CPU 11 determines whether or not the category is the same as a predetermined category. In the case where it is determined that the category is the same as the predetermined category (step 5106: YES), the CPU 11 proceeds to step S107. In the case where it is determined that the category is different from the predetermined category (step S106: NO), the CPU 11 proceeds to step S108. For example, in the case where the category is a troubleshooting guide, the CPU 11 proceeds to step S107.

In step S107, the CPU 11 notifies the person in charge U3 of the second response of identification information about the person in charge U4 of the third response. The CPU 11 proceeds to step S108. The identification information is, for example, the name, telephone number, or e-mail address of the person in charge, or the like.

In step S108, the CPU 11 assigns the inquiry to the person in charge U3 of the second response. The CPU 11 ends the assigning process.

FIG. 8 illustrates an example of an assigning table for the information processing apparatus 10 according to an exemplary embodiment. The assigning table includes a team field and a category field. The team field is a field in which a value for identifying a team is stored. The information processing apparatus 10 determines, based on the assigning table, a corresponding team for each category. That is, in the case where an inquiry is assigned to one of a plurality of persons in charge U3 of the second response, the information processing apparatus 10 assigns the inquiry to a person in charge U3 of the second response corresponding to the category of the inquiry.

In step S109, the CPU 11 notifies the person in charge U2 of the first response of identification information about the person in charge U3 of the second response. The identification information is, for example, the name, telephone number, or e-mail address of the person in charge, or the like. The CPU 11 proceeds to step S110.

In step S110, the CPU 11 assigns the inquiry to the person in charge U2 of the first response. The CPU 11 ends the assigning process.

As described above, in the processing of steps S101 to S110, in the case where the urgency level determined based on the details of the inquiry meets the predetermined condition, the CPU 11 assigns the inquiry to a person in charge of the second or later response, which is the stage subsequent to the first response as a first point of contact.

Furthermore, in the processing of step S103 and steps S106 to S107, in the case where the inquiry is assigned to a person in charge U3 of the second response, when the category determined based on the details of the inquiry is the same as a predetermined category, the CPU 11 notifies the person in charge U3 of the second response of identification information about the person in charge U4 of the third response, which is the stage subsequent to the second response.

Furthermore, in the processing of steps S103 to S109, even in the case where the urgency level of the inquiry meets the predetermined condition, when assigning of the inquiry to a person in charge of the second or later response is prohibited due to a contract related to the inquiry or the like, the CPU 11 assigns the inquiry to the person in charge U2 of the first response. Furthermore, the CPU 11 notifies the person in charge U2 of the first response of identification information about the person in charge U3 of the second response.

FIG. 9 is a flowchart illustrating a response process performed by the information processing apparatus 10. The response process is implemented when the CPU 11 reads the assigning program from the ROM 12 or the storage 14, loads the assigning program onto the RAM 13, and executes the assigning program.

In step S121, the CPU 11 assigns an inquiry to the person in charge U4 of the third response. For example, when a request is issued from the person in charge U3 of the second response, the CPU 11 assigns the inquiry to the person in charge U4 of the third response. The CPU 11 proceeds to step S122.

In step S122, the CPU 11 receives a response from the person in charge U4 of the third response. The CPU 11 proceeds to step S123.

In step S123, the CPU 11 associates the response with the inquiry. The CPU 11 ends the response process.

As described above, in the processing of steps S121 to S123, the CPU 11 stores the details of the response that the person in charge U4 of the third response has made to the inquiry, in association with the details of the inquiry.

### Modifications

Although the information processing apparatus 10 according to an exemplary embodiment has been described above, the present disclosure is not limited to the exemplary embodiment described above. Various improvements and modifications may be made.

In the case where a difference between the time at which an inquiry was made (occurrence time of the inquiry) and the time at which the first response will be able to be made (possible response time of the first response) exceeds a predetermined time, the information processing apparatus 10 according to an exemplary embodiment may assign the inquiry to a person in charge of the second or later response. For example, in the case where there is a time difference between the location of the inquiring person U1 and the location of the person in charge U2 of the first response, the information processing apparatus 10 assigns the inquiry to the person in charge U3 of the second response.

In the case where the urgency level of an inquiry meets a predetermined condition, the information processing apparatus 10 according to an exemplary embodiment may assign the inquiry to the person in charge U4 of the third response. Furthermore, in the case where the category of an inquiry is the same as a predetermined category, the information processing apparatus 10 may assign the inquiry to the person in charge U4 of the third response. That is, in step S107 in FIG. 5, the CPU 11 assigns the inquiry to the person in charge U4 of the third response, instead of sending notification, and ends the assigning process.

The processes described above may be implemented by a dedicated hardware circuit. In this case, the processes may be performed by a single piece of hardware or a plurality of pieces of hardware.

Furthermore, a program for causing the information processing apparatus 10 to operate may be provided by a computer-readable recording medium such as a universal serial bus (USB) memory, a flexible disc, or a compact disc-read only memory (CD-ROM) or may be provided online through a network such as the Internet. Typically, in this case, the program recorded on the computer-readable recording medium is transferred to and stored in a memory, a storage, or the like. Furthermore, for example, the program may be provided as a separated piece of application software or may be integrated as a function of the information processing apparatus 10 into software of the apparatus.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing apparatus comprising:

a processor configured to:
in a case where an urgency level determined based on details of an inquiry meets a predetermined condition, assign the inquiry to a person in charge of a second or later response that is a stage subsequent to a first response as a first point of contact.
(((2)))

The information processing apparatus according to (((1))), wherein the processor is configured to, in a case where the inquiry is assigned to a person in charge of the second response, when a category determined based on the details of the inquiry is same as a predetermined category, notify the person in charge of the second response of identification information about a person in charge of a third response that is a stage subsequent to the second response.
(((3)))

The information processing apparatus according to (((2))), wherein the processor is configured to store, in association with the details of the inquiry, details of a response that the person in charge of the third response has made to the inquiry.
(((4)))

The information processing apparatus according to any one of (((1))) to (((3))), wherein the processor is configured to, even in a case where the urgency level of the inquiry meets the predetermined condition, when assigning of the inquiry to the person in charge of the second or later response is prohibited, assign the inquiry to a person in charge of the first response.
(((5)))

The information processing apparatus according to (((4))), wherein the processor is configured to notify the person in charge of the first response of identification information about a person in charge of the second response.
(((6)))

The information processing apparatus according to any one of (((1))) to (((5))), wherein the processor is configured to, in a case where a difference between an occurrence time of the inquiry and a possible response time of the first response exceeds a predetermined time, assign the inquiry to the person in charge of the second or later response.
(((7)))

An information processing program for causing a processor to execute a process comprising: in a case where an urgency level determined based on details of an inquiry meets a predetermined condition, assigning the inquiry to a person in charge of a second or later response that is a stage subsequent to a first response as a first point of contact.

What is claimed is:

1. An information processing apparatus comprising:
a processor configured to:
in a case where an urgency level determined based on details of an inquiry meets a predetermined condition, assign the inquiry to a person in charge of a second or later response that is a stage subsequent to a first response as a first point of contact.

2. The information processing apparatus according to claim 1, wherein the processor is configured to, in a case where the inquiry is assigned to a person in charge of the second response, when a category determined based on the details of the inquiry is same as a predetermined category, notify the person in charge of the second response of identification information about a person in charge of a third response that is a stage subsequent to the second response.

3. The information processing apparatus according to claim 2, wherein the processor is configured to store, in association with the details of the inquiry, details of a response that the person in charge of the third response has made to the inquiry.

4. The information processing apparatus according to claim 1, wherein the processor is configured to, even in a case where the urgency level of the inquiry meets the predetermined condition, when assigning of the inquiry to the person in charge of the second or later response is prohibited, assign the inquiry to a person in charge of the first response.

5. The information processing apparatus according to claim 4, wherein the processor is configured to notify the person in charge of the first response of identification information about a person in charge of the second response.

6. The information processing apparatus according to claim 1, wherein the processor is configured to, in a case where a difference between an occurrence time of the inquiry and a possible response time of the first response exceeds a predetermined time, assign the inquiry to the person in charge of the second or later response.

7. An information processing method comprising:
in a case where an urgency level determined based on details of an inquiry meets a predetermined condition, assigning the inquiry to a person in charge of a second or later response that is a stage subsequent to a first response as a first point of contact.

8. A non-transitory computer readable medium storing a program causing a computer to execute a process for information processing, the process comprising:
in a case where an urgency level determined based on details of an inquiry meets a predetermined condition, assigning the inquiry to a person in charge of a second or later response that is a stage subsequent to a first response as a first point of contact.
